(19) United States
(12) Patent Application Publication
(10) Pub. No.: US 2026/0166794 A1
(43) Pub. Date: Jun. 18, 2026

(54) MOLDING MACHINE AND INFORMATION PROVIDING DEVICE

(71) Applicant: SUMITOMO HEAVY INDUSTRIES, LTD., Tokyo (JP)

(72) Inventors: Daigo HOTTA, Chiba-shi (JP); Tomosuke KADOONO, Chiba-shi (JP); Atsuro TAMURA, Chiba-shi (JP)

(21) Appl. No.: 19/423,079

(22) Filed: Dec. 17, 2025

(30) Foreign Application Priority Data
Dec. 18, 2024 (JP) 2024-221832

(51) Int. Cl. B29C 45/76; G06Q 10/0639

(52) U.S. Cl. CPC B29C 45/766; G06Q 10/06395; G06Q 10/06398; B29C 2045/7606; B29C 2945/76913

(57) ABSTRACT

A molding machine includes: an acquisition unit that acquires a level of a user; and an information providing unit that provides information to the user, in which the information providing unit changes information of advice to be provided regarding a function that is available to both a user having a relatively high level and a user having a relatively low level, according to the level acquired by the acquisition unit.

### CROSS-REFERENCE TO RELATED APPLICATIONS

This application claims priority to Japanese Patent Application No. 2024-221832, filed on Dec. 18, 2024, which is incorporated by reference herein in its entirety.

### BACKGROUND

### Technical Field

A certain embodiment of the present invention relates to a molding machine and an information providing device.

### Description of Related Art

The related art describes a molding machine in which users are grouped according to job roles (administrator, worker, and the like) and only operation authority according to the job roles is granted to each group.

The related art describes an injection molding machine including a touch panel, in which an access level that allows or prohibits display is set for all screens that can be displayed on the touch panel, and display is restricted according to the authority of an operator.

### SUMMARY

According to an embodiment of the present invention, there is provided a molding machine including acquisition means that acquires a level of a user, and information providing means that provides information to the user, in which the information providing means changes information of advice to be provided regarding a function that is available to both a user having a relatively high level and a user having a relatively low level, according to the level acquired by the acquisition means.

### BRIEF DESCRIPTION OF THE DRAWINGS

FIG. 1 is a view showing a configuration of an injection molding machine to which the present embodiment is applied.

FIG. 2 is a view showing a configuration of a control device.

FIG. 3 is a view showing a configuration of a data processing device.

FIG. 4 is a view showing a configuration of an information providing device.

FIG. 5 is a view showing a hardware configuration example of a computer that realizes the control device, the data processing device, and the information providing device.

FIGS. 6A and 6B are flowcharts showing an example of a flow of work in a case where a user implements a countermeasure in a case where a defect occurs in the injection molding machine, FIG. 6A shows an example of a flow of work performed by a user having a relatively high skill level of work, and FIG. 6B shows an example of a flow of work performed by a user having a relatively low skill level of work.

FIG. 7 is a diagram showing an example of a table in which a time required for work and a level of a user are associated with each other.

FIG. 8 is a diagram showing an example of a table in which information provided to the user and a level of the user are associated with each other.

FIG. 9 is a view showing an example of a flow of processing related to providing information to the user performed by the information providing device.

FIG. 10 is a view showing a configuration of an information providing device according to a modification example.

FIG. 11 is a view showing an example of a flow of processing related to providing information to the user performed by the information providing device according to the modification example.

### DETAILED DESCRIPTION

In the molding machine, information to be provided may be different depending on the role of the user. For example, in a case where there are functions that can be used and functions that cannot be used depending on the role of the user, only information about the functions that can be used may be provided to the user. However, necessary information may be different depending on a skill level of a user in performing the work, for example, regardless of the role of the user. Therefore, even in a case where the information to be provided is different depending on the role of the user, there is a case where the information required by the user cannot be provided.

It is desirable to provide a user with more suitable information, as compared with a case where information to be provided is not varied according to a level of the user with regard to a function that can be used regardless of the level of the user.

Hereinafter, an embodiment of the present invention will be described in detail with reference to the accompanying drawings.

### Device Configuration

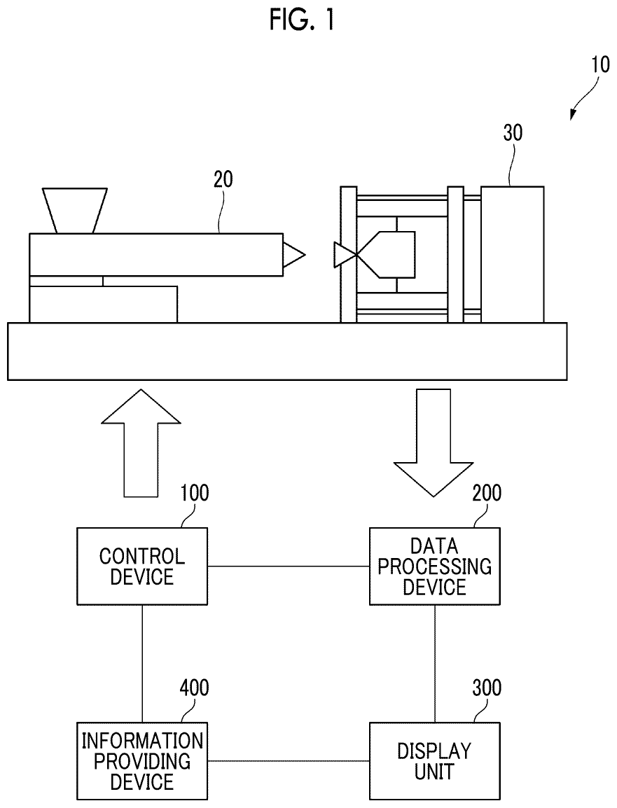

FIG. 1 is a view showing a configuration of an injection molding machine 10 to which the present embodiment is applied. The injection molding machine 10 includes an injection unit 20, a mold clamping unit 30, a control device 100, a data processing device 200, a display unit 300, and an information providing device 400. In the following description, a direction from the injection unit 20 toward the mold clamping unit 30 may be referred to as a front. The injection molding machine 10 is an example of a molding machine.

The injection unit 20 is configured with a cylinder that heats a molding material, a screw that is rotatable in the cylinder and that is capable of advancing and retreating in an axial direction, a rotary motor that drives the screw in a rotation direction, a motor that drives the screw in the axial direction, and the like. The molding material is, for example, a resin. The injection unit 20 injects the molding material that is heated and liquefied in the cylinder by advancing the screw in a front direction while rotating the screw, and fills a mold of the mold clamping unit 30 disposed in front of the injection unit 20. The injection unit 20 performs, for example, a plasticizing process, a filling process, a pressure holding process, or the like in a manufacturing process of a molding product. The filling process and the pressure holding process may be collectively referred to as an injection process.

The mold clamping unit 30 includes the mold, a clamping mechanism that clamps the mold, a motor that drives the clamping mechanism, and the like. The mold clamping unit 30 closes the mold to receive the molding material injected from the injection unit 20 into an inside of the mold. In this case, the mold clamping unit 30 clamps the mold by means of a clamping mechanism such that the mold does not open due to the filling of the molding material (mold clamping). A molding product is produced by solidifying the molding material filled in the mold. After that, the mold clamping unit 30 opens the mold and ejects the produced molding product. The mold clamping unit 30 performs, for example, a mold closing process, a pressure increasing process, a mold clamping process, a depressurizing process, a mold opening process, or the like in the manufacturing process of the molding product.

The control device 100 is a device that controls operations of the injection unit 20 and the mold clamping unit 30. The data processing device 200 is a device that processes data obtained as the injection unit 20 and the mold clamping unit 30 operate. The display unit 300 displays information related to the control of the injection unit 20 and the mold clamping unit 30 by the control device 100, data acquired by the data processing device 200, a processing result of the data processing device 200, and the like. In addition, the display unit 300 displays an operation screen for performing an operation to input commands or data to the control device 100 and the data processing device 200. In addition, the display unit 300 displays information of advice provided to a user. The information providing device 400 is a device that determines the advice information to be provided to the user of the injection molding machine 10 and causes the display unit 300 to display the information of the advice. The information of the advice may be displayed on a display screen other than the display unit 300.

### Configuration of Control Device 100

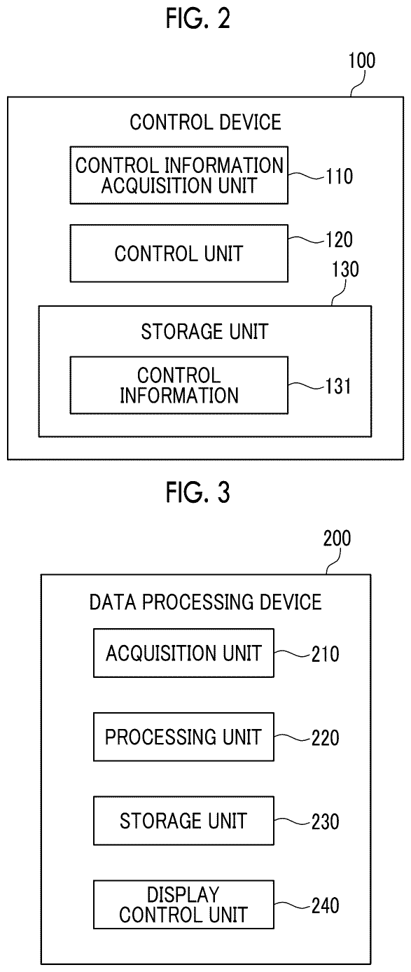

FIG. 2 is a view showing a configuration of the control device 100. The control device 100 controls operations of the injection unit 20 and the mold clamping unit 30. The control device 100 is realized by, for example, a computer. The control device 100 includes a control information acquisition unit 110, a control unit 120, and a storage unit 130. The control device 100 controls the injection unit 20 and the mold clamping unit 30 to repeatedly perform a process related to the manufacturing of the molding product, thereby repeatedly manufacturing the molding product. The process related to the manufacturing of the molding product includes a plasticizing process, a mold closing process, a pressure increasing process, a mold clamping process, a filling process, a pressure holding process, a cooling process, a depressurizing process, a mold opening process, an ejection process, and the like. Hereinafter, these processes related to the manufacturing may be collectively referred to as a “manufacturing process”. In addition, a series of operations for obtaining a molding product, for example, an operation from the start of the plasticizing process in the above manufacturing process to the start of the next plasticizing process is referred to as a “shot”, a “molding cycle”, or the like. In addition, each of the above processes for manufacturing the molding product is merely an example. For example, as a process executed in one shot, another process not included in the above may be included.

The control information acquisition unit 110 acquires control information used to control the injection unit 20 and the mold clamping unit 30. The control information is a condition set by the user, and, for example, is input by the user using an input unit (not shown). For example, the control information includes molding conditions such as a resin temperature, a mold temperature (a cylinder temperature), an injection pressure holding time, a metering value, a V-P switching position, a pressure holding, an injection speed (a filling speed), a screw rotation speed, a screw back pressure, and a mold clamping force. A plurality of combinations of these molding conditions are determined depending on the molding product and the mold. Hereinafter, the combination data of the molding conditions will be also referred to as a molding condition data set. The control information acquisition unit 110 stores the acquired control information in the storage unit 130 as the molding condition data set.

The control unit 120 controls the injection unit 20 and the mold clamping unit 30 by using the above molding condition data set, and performs a process related to the manufacturing (shot) of the molding product including each of the above processes. The control unit 120 reads a molding condition data set corresponding to the molding product to be manufactured from the storage unit 130, for example, in a case where the manufacturing of the molding product starts. Then, the control unit 120 controls the operations of the injection unit 20 and the mold clamping unit 30 based on the read control information. Specifically, the control unit 120 controls the injection unit 20 and the mold clamping unit 30 such that the data obtained from the injection unit 20 and the mold clamping unit 30 in the manufacturing process matches a setting value of the molding condition data set. In addition, the control unit 120 may cause the display unit 300 to display the molding condition data set read from the storage unit 130. The user may refer to the data of the molding conditions displayed on the display unit 300 and may perform an operation such as correcting a value as necessary.

The storage unit 130 holds control information 131 acquired by the control information acquisition unit 110. The molding condition data set included in the control information 131 is prepared in association with a molding product to be manufactured and the mold. The storage unit 130 holds a molding condition data set for each molding product to be manufactured and each mold. In addition, although not shown, the storage unit 130 holds a program for the control unit 120 to control the injection unit 20 and the mold clamping unit 30. As will be described in detail later, the function of the control unit 120 is realized by a processor of the control device 100 reading and executing the program held in the storage unit 130.

### Configuration of Data Processing Device 200

FIG. 3 is a view showing a configuration of the data processing device 200. The data processing device 200 acquires and processes data obtained as the injection unit 20 and the mold clamping unit 30 execute operations in the process related to the manufacturing of the molding product. The data processing device 200 is realized by, for example, a computer. The data processing device 200 includes an acquisition unit 210, a processing unit 220, a storage unit 230, and a display control unit 240.

The acquisition unit 210 acquires data to be processed from the injection unit 20 and the mold clamping unit 30. Various sensors and detectors are attached to the injection unit 20 and the mold clamping unit 30. The data acquired by the sensors and the detectors (hereinafter, referred to as “acquisition data”) is information representing a molding result of the injection unit 20 and the mold clamping unit 30, and is used for quality control of the molding product. Specifically, for example, the weight of the molding product, the dimensions of the molding product, the mold internal pressure, the minimum cushion position, and the feature values of the waveform of the filling pressure are included. The acquisition data is an actual value obtained in a manufacturing process of the molding product. The acquisition unit 210 receives the acquisition data transmitted from the sensor and the detector and stores the acquisition data in the storage unit 230.

The processing unit 220 processes the acquisition data stored in the storage unit 230. Specifically, the processing unit 220 performs processing of extracting a representative value of the acquisition data in each process and processing of generating time series data in which the acquisition data in each process is arranged in chronological order. In extracting the representative value, the processing unit 220 performs statistical processing such as calculating an average value, specifying a range of values, and specifying a maximum value or a minimum value on the acquisition data.

The storage unit 230 holds the representative value, the time series data, the statistical data, and the like, processed by the processing unit 220. The data is associated with, for example, the original acquisition data. Specifically, the data may be stored in a data file of the original acquisition data corresponding to the data. In addition, the data file in which data is stored may be associated with the data file of the original data. Accordingly, each piece of data generated by the processing unit 220 is also held in association with the molding product to be manufactured and the mold in the shot in which the original acquisition data is obtained. As the data format of the data file held in the storage unit 230, for example, comma-separated values (CSV), Extensible Markup Language (XML), JavaScript Object Notation (JSON), or the like can be used.

In addition, although not shown, the storage unit 230 holds a program for the processing unit 220 to execute data processing. As will be described in detail later, the processor of the data processing device 200 reads and executes the program held in the storage unit 230, so that functions of the processing unit 220 are realized.

The display control unit 240 causes the display unit 300 to display the acquisition data and the data of the processing result by the processing unit 220. The data to be displayed includes setting information in the control information used by the control device 100 to control the injection unit 20 and the mold clamping unit 30. The setting information (setting value) can be acquired from the control device 100. The display control unit 240 acquires the data from the storage unit 230 and the storage unit 130 of the control device 100 and causes the data to be displayed on the display unit 300.

### Configuration OF Information Providing Device 400

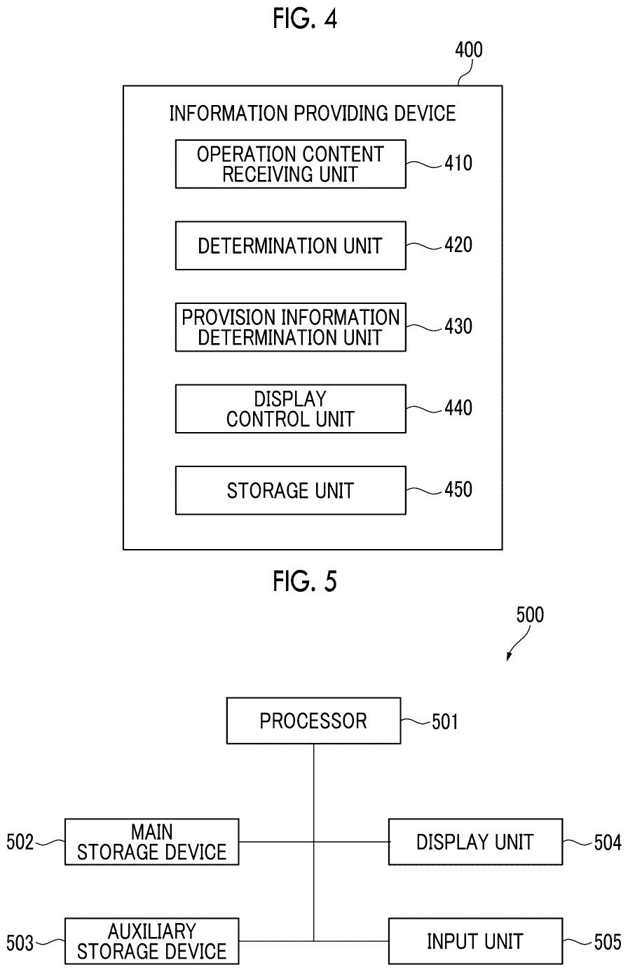

FIG. 4 is a view showing a configuration of the information providing device 400. The information providing device 400 includes an operation content receiving unit 410, a determination unit 420, a provision information determination unit 430, a display control unit 440, and a storage unit 450.

The operation content receiving unit 410 receives and acquires an operation content from the user. The user performs an operation by using an operation screen displayed on the display unit 300, for example. The operation content is the content of the operation performed by the user on the injection molding machine 10, and includes a process, a time, the number of times of execution, a transition screen, an input content, and the like related to the operation.

The determination unit 420 determines a level of the user. The determination unit 420 determines the level of the user, for example, based on the operation content acquired by the operation content receiving unit 410. The level of the user is an index that is a criterion for determining the information of the advice to be provided to the user, and is, for example, an index indicating a skill level of the user in the work. In addition, the level of the user may indicate the role of the user, such as a job title. The determination unit 420 determines the level of the user in comparison with the operation content of the user with the determination criterion stored in the storage unit 450. Details of the determination of the level of the user by the determination unit will be described later. The determination unit 420 is an example of acquisition means for acquiring the level of the user.

The provision information determination unit 430 determines the information to be provided to the user. The provision information determination unit 430 determines the information to be provided to the user, based on the level of the user determined by the determination unit 420. Here, the information provided to the user is, for example, information of advice provided related to a function that can be used by both a user having a relatively high level and a user having a relatively low level. The provision information determination unit 430 changes the information of the advice to be provided according to the level of the user. Details of the determination of the provision information by the provision information determination unit 430 will be described later.

The display control unit 440 causes the display unit 300 to display the information of the advice to be provided to the user determined by the provision information determination unit 430. The information of the advice may be displayed on the display unit 300, for example, in a pop-up manner, or the information of the advice may be displayed according to a user's selection. In addition, the information of the advice may be displayed on a display screen other than the display unit 300. For example, the information of the advice may be transmitted to a terminal possessed by the user, such as a PC or a smartphone, and may be configured to be displayed on the terminal.

The provision information determination unit 430 and the display control unit 440 are examples of information providing means for providing the information to the user.

The storage unit 450 stores a determination criterion for the level and the provision information for each level.

The determination criterion for the level is, for example, a time required for a specific operation, the number of times of execution of the operation, or the like. For example, the storage unit 450 stores a reference time or the number of times of execution for each operation in association with the level. For example, the determination unit 420 determines the level of the user in comparison with a time required for the user to perform an operation.

In addition, the storage unit 450 stores the provision information for each level in association with the level. The provision information determination unit 430 acquires the provision information according to the determined level of the user from the storage unit 450 and determines the provision information.

### Hardware Configuration of Computer Realizing Control Device 100, Data Processing Device 200, and Information Providing Device 400

FIG. 5 is a view showing a hardware configuration example of a computer 500 that realizes the control device 100, the data processing device 200, and the information providing device 400. The computer 500 shown in FIG. 5 includes a processor 501 serving as a calculation means, and a main storage device (main memory) 502 and an auxiliary storage device 503 serving as storage means. As the processor 501, for example, various calculation circuits such as a central processing unit (CPU), a graphics processing unit (GPU), an application-specific integrated circuit (ASIC), and a field-programmable gate array (FPGA) are used. The processor 501 reads a program stored in the auxiliary storage device 503 into the main storage device 502 and executes the program. For example, a random-access memory (RAM) is used as the main storage device 502. For example, a magnetic disk device, a solid-state drive (SSD), or the like is used as the auxiliary storage device 503.

In addition, the computer 500 includes a display unit (display) 504 and an input unit 505 through which a user performs an input operation. For example, a keyboard, a mouse, or the like is used as the input unit 505. Further, a touch panel configured integrally with the display unit 504 may be used as the input unit 505. The display unit 504 may be realized by the display unit 300 shown in FIG. 1. In addition, a configuration of the computer 500 shown in FIG. 5 is merely an example, and the computer 500 used in the present embodiment is not limited to the configuration example of FIG. 5. For example, the configuration may include a non-volatile memory such as a flash memory, or a read-only memory (ROM) may be provided as the storage device.

In a case where the control device 100 is realized by the computer shown in FIG. 5, the control information acquisition unit 110 is realized by, for example, the processor 501 that reads and executes the program and the input unit 505. The function of the control unit 120 is realized, for example, by the processor 501 reading and executing the program. The storage unit 130 is realized by, for example, the auxiliary storage device 503.

In a case where the data processing device 200 is realized by the computer shown in FIG. 5, the functions of the acquisition unit 210 and the processing unit 220 are realized by, for example, the processor 501 reading and executing the program. The storage unit 230 is realized by, for example, the auxiliary storage device 503. The display control unit 240 is realized by the processor 501 that reads and executes the program.

In a case where the information providing device 400 is realized by the computer 500 shown in FIG. 5, the functions of the operation content receiving unit 410, the determination unit 420, the provision information determination unit 430, and the display control unit 440 are realized, for example, by the processor 501 reading and executing the program. The storage unit 450 is realized by, for example, the auxiliary storage device 503.

### Level Determination

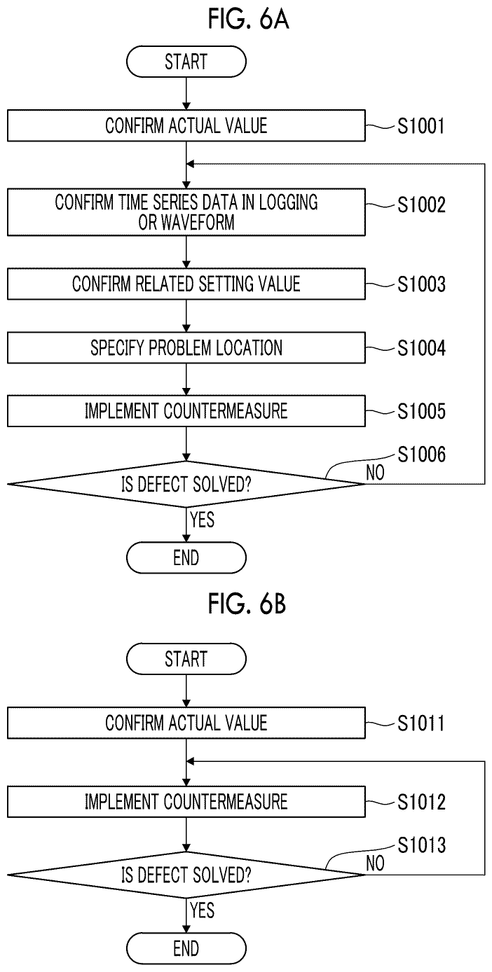

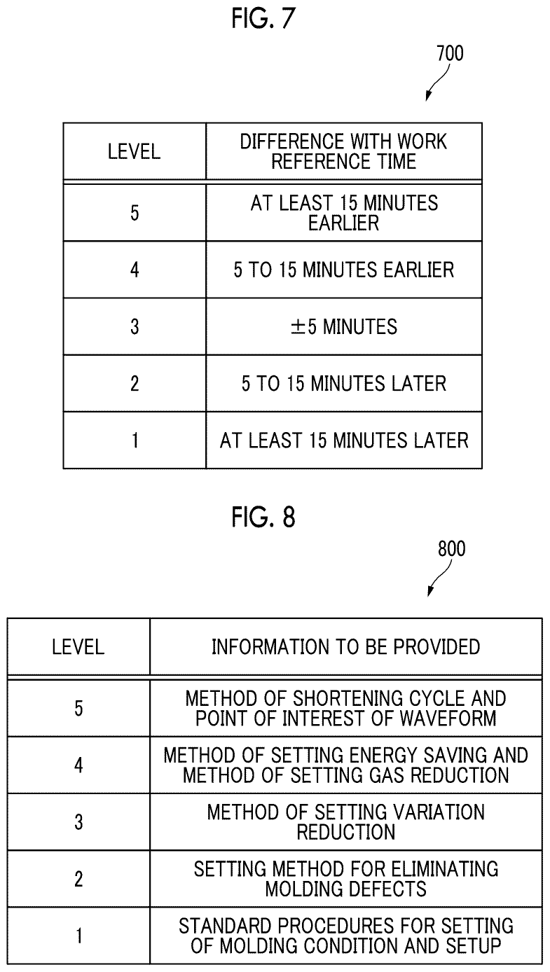

An example of a method for determining a level in the present embodiment will be described with reference to FIGS. 6A and 7.

FIGS. 6A and 6B are flowcharts showing an example of a flow of work in a case where a user implements a countermeasure in a case where a defect occurs in the injection molding machine 10. FIG. 6A shows an example of a flow of work performed by a user having a relatively high skill level of the work, and FIG. 6B shows an example of a flow of work performed by a user having a relatively low skill level of the work.

As shown in FIG. 6A, in a case where a defect occurs, first, the user having a relatively high skill level of the work checks an actual value (Step S1001). The user checks the actual value in one shot in which the defect has occurred. Next, the user checks time series data in a logging or waveform (Step S1002). Next, the user checks a setting value related to the defect that has occurred (Step S1003). Next, the user identifies the problem location based on the information acquired through the checking (Step S1004). Then, the user implements a countermeasure for resolving the defect with respect to the identified problem location (Step S1005). In a case where the defect is resolved (YES in Step S1006), the work is ended. On the other hand, in a case where the defect is not resolved (NO in Step S1006), the user performs the work again from Step S1002. A user having a relatively high skill level in the work tends to identify the problem location by checking the time series data.

On the other hand, a user having a relatively low skill level in the work tends to execute a countermeasure without following a procedure such as checking time series data. The user having a relatively low skill level in the work first checks the actual value in a case where the defect occurs, as shown in FIG. 6B (Step S1011). Then, the user implements a countermeasure for resolving the defect (Step S1012). In a case where the defect is resolved (YES in Step S1013), the work is ended. On the other hand, in a case where the defect is not resolved (NO in Step S1013), the user implements a different countermeasure again.

In this way, since a difference in level is reflected in the operation content, the level of the user can be determined based on the operation content. For example, the level of the user is determined depending on whether or not the user has checked a specific setting value in resolving the defect.

In addition, the level of the user may be determined from the time required for the work.

FIG. 7 is a diagram showing an example of a table 700 in which a time required for the work and a level of the user are associated with each other. The table 700 is stored in the storage unit 450.

The table 700 is a correspondence table between a difference between a time required for certain work and a work reference time and the level of the user. The work reference time is determined in advance for each work. In addition, the table 700 is provided for each work.

In the example shown in FIG. 7, for example, the user at level 5 completes the work at least 15 minutes earlier than the work reference time. A user at level 4 completes the work 5 to 15 minutes earlier than the work reference time. A user at level 3 completes the work within ±5 minutes with respect to the work reference time. A user at level 2 completes the work 5 to 15 minutes later than the work reference time. A user at level 1 completes the work at least 15 minutes later than the work reference time. The determination unit 420 determines the level of the user in comparison with the operation time of the user with the table 700. For example, in a case where the user performs the work with a work reference time of 30 minutes in 40 minutes, the determination unit 420 determines the user as level 2.

The above method is an example, and the level may be determined by another method. For example, the level may be determined based on the content displayed on the screen that is checked by the user during the operation.

### Determination of Provision Information

The provision information provided to the user is determined by the provision information determination unit 430. The provision information determination unit 430 determines, for example, information of advice required to execute the work as the provision information for a user having a relatively low level. The information of advice required for the execution of the work is, for example, information of advice related to the execution procedure of the work or a method of setting a setting value in the injection molding machine 10. For example, the provision information determination unit 430 determines, for example, the information of advice related to the procedure for starting condition setting, such as “gradually refine a V-P switching position from a relationship between a product volume and a screw diameter”.

In addition, the provision information determination unit 430 determines, for example, information of the advice for improving the quality of the molding product as the provision information for the user having a relatively low level. For example, the information of the advice for improving the quality is information for eliminating or not generating a defect with a high frequency of occurrence. For example, the provision information determination unit 430 determines “increase a holding pressure” as the information of the advice to be provided regarding the pressure holding setting in a case where a sink mark occurs. In addition, for example, in relation to the injection speed setting in a case where jetting occurs, “reduce the injection speed” is determined as the information of the advice. In addition, for example, in relation to the mold clamping force setting in a case where burrs occur, “increase the mold clamping force” is determined as the information of the advice.

In this way, the provision information determination unit 430 determines the information of the advice related to the basic operation or the quality improvement as the provision information for the user having a relatively low level.

On the other hand, the provision information determination unit 430 determines the information of the advice having added value as the provision information for the user having a relatively high level. The information of the advice having the added value is the information of the advice that brings an additional effect associated with the execution of the work while satisfying the quality standard of the molding product.

For example, the provision information determination unit 430 determines information of advice for reducing energy consumption as the provision information for a user having a relatively high level. The information of the advice for reducing the energy consumption includes, for example, guidance to an energy-saving pressure holding setting field or prompting the use of a lock-up function in a toggle type molding machine with respect to the setting of the pressure holding.

For example, the provision information determination unit 430 determines information of advice for reducing the mold clamping force as the provision information for the user having a relatively high level. Examples of the information of the advice for reducing the mold clamping force include guidance to a setting screen of the mold clamping force and guidance to detection of a minimum mold clamping force. In addition, the information of advice related to a way of capturing a mold clamping force waveform for reducing the mold clamping force may be determined as the provision information. For example, the provision information determination unit 430 determines, as information of advice to be provided, “prompting to check the presence or absence of an increase in the mold clamping force at the time of occurrence of the filling peak pressure”. In addition, for example, it is determined that “the mold clamping force is lowered in a case where the increase of the waveform is not observed” as the information of advice to be provided.

In addition, for example, the provision information determination unit 430 may determine information of advice for reducing mold deposits adhering to a gas or the mold as the provision information for a user having a relatively high level. For example, the provision information determination unit 430 determines information for guidance to a setting screen for the mold clamping force in the pressure holding process as the provision information.

In addition, for example, the provision information determination unit 430 determines information of advice for shortening a cycle related to the mold clamping speed setting as the provision information for the user having a relatively high level. For example, the provision information determination unit 430 determines that “decelerate just before the guide pin enters” as the information of advice to be provided.

FIG. 8 is a diagram showing an example of a table 800 in which information provided to the user and a level of the user are associated with each other. The table 800 is stored in the storage unit 450.

The table 800 is a correspondence table between information to be provided to the user and the level of the user. In the example shown in FIG. 8, a method of shortening the cycle and the point of interest of the waveform are determined as the provision information for the user at level 5. A method of setting energy saving and a method of setting gas reduction are determined as the provision information for the user at level 4. A method of setting variation reduction is determined as the provision information for the user at level 3. A setting method for eliminating molding defects is determined as the provision information for the user at level 2. For the user at level 1, the standard procedures for setting of the molding condition and the setup are determined as the provision information.

### Flow of Information Provision Processing

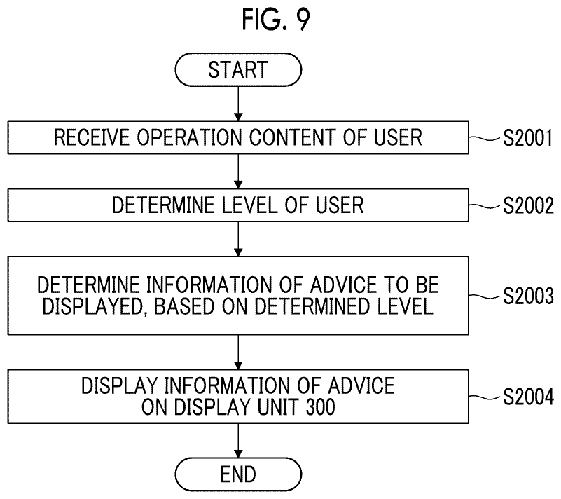

FIG. 9 is a view showing an example of a flow of processing related to providing information to the user by the information providing device 400. Here, an example of a case where the level of the user is determined using the table shown in FIG. 7 and the provision information is determined using the table 800 shown in FIG. 8 will be described.

In FIG. 9, first, the operation content receiving unit 410 receives the operation content from the user (Step S2001). Here, it is assumed that the user completes the work in 50 minutes for the work in which the work reference time is 40 minutes. The operation content receiving unit 410 receives the content of the work and the fact that the user took 50 minutes to complete the work as the operation content by the user.

Next, the determination unit 420 determines the level of the user (Step S2002). The determination unit 420 acquires the table 700 corresponding to the operation performed by the user from the storage unit 450, and determines the level of the user in comparison with the operation content of the user. Here, since the user completes the work 10 minutes later than the work reference time, the determination unit 420 determines the level of the user to be 2.

Next, the provision information determination unit 430 determines the information of the advice to be displayed, based on the determined level (Step S2003). The provision information determination unit 430 acquires the table 800 from the storage unit 450, and determines the information associated with the determined level as the provision information. Here, since the level of the user is determined to be 2, the provision information determination unit 430 determines the information of the advice for providing the setting method for eliminating the molding defects.

Then, the display control unit 440 causes the display unit 300 to display the information of the advice (Step S2004). The display control unit 440 causes the display unit 300 to display the setting method for eliminating the molding defects.

In the present embodiment, a configuration in which the level of the user is determined based on the operation content has been described as a method of acquiring the level of the user. However, the present invention is not limited thereto. For example, a configuration in which the level of the user is stored in the storage unit 450 in association with a user ID, and the level of the user who performs the work is acquired may be adopted. In the following modification example, an example in a case where the level of the user is managed by the storage unit 450 will be described.

### Modification Example

An information providing device 400 according to the modification example stores the level of the user in association with the user ID in the storage unit 450.

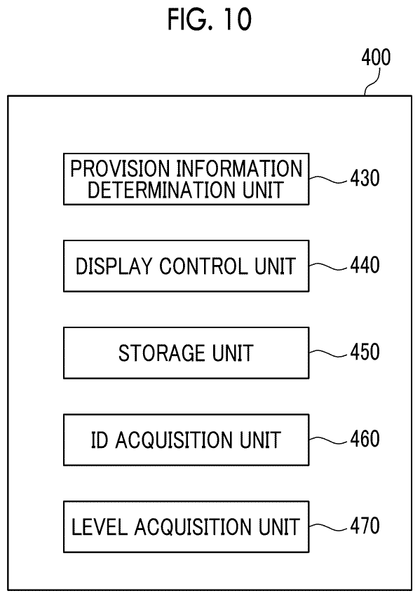

FIG. 10 is a view showing a configuration of the information providing device 400 according to the modification example. The information providing device 400 according to the modification example includes a provision information determination unit 430, a display control unit 440, a storage unit 450, an ID acquisition unit 460, and a level acquisition unit 470. The provision information determination unit 430, the display control unit 440, and the storage unit 450 have the same functions as the corresponding configurations shown in FIG. 4. In the modification example, the storage unit 450 further stores the level of the user in association with the user ID.

The ID acquisition unit 460 acquires an ID of the user who performs an operation with respect to the injection molding machine 10. For example, the ID acquisition unit 460 acquires the ID of the user by using radio-frequency identification (RFID).

The level acquisition unit 470 acquires the level of the user associated with the ID of the user acquired by the ID acquisition unit 460 from the storage unit 450.

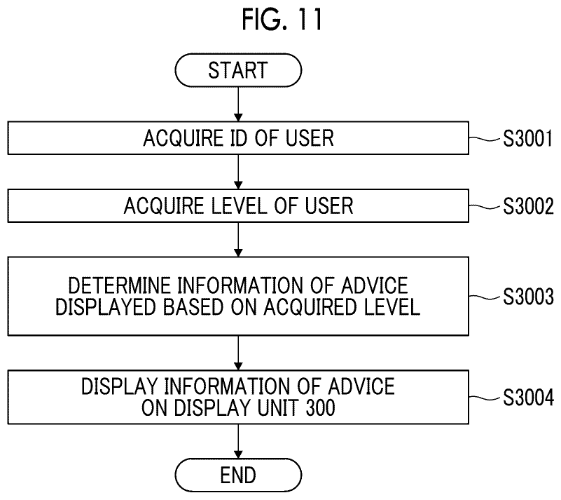

FIG. 11 is a view showing an example of a flow of processing related to providing information to the user performed by the information providing device 400 according to the modification example.

In FIG. 11, first, the ID acquisition unit 460 acquires the ID of the user who performs the operation with respect to the injection molding machine 10 (Step S3001). Next, the level acquisition unit 470 acquires the level of the user from the storage unit 450 (Step S3002). The level of the user is stored in the storage unit 450 in association with the user ID, and the level acquisition unit 470 acquires the level of the user associated with the user ID of the user who performs the operation.

Next, the provision information determination unit 430 determines the information of the advice to be displayed, based on the acquired level (Step S3003). The provision information determination unit 430 acquires the table 800 from the storage unit 450, and determines the information associated with the acquired level as the provision information.

Then, the display control unit 440 causes the display unit 300 to display the information of the advice (Step S3004).

The processing shown in FIG. 11 is an example, and is not limited thereto. For example, the user may be managed by a password. For example, the ID acquisition unit 460 receives an input of the password from the user and acquires the ID of the user.

In addition, management may be performed not for each individual, but in units of groups in which users of the same level are grouped together. For example, a configuration may be adopted in which the password is assigned to a group of users at the same level, and the level is determined from the input of the password.

Although the embodiment of the present invention has been described above, the technical scope of the present invention is not limited to the above embodiment. For example, the information stored in the storage unit 450 may be managed in an external server connected to the information providing device 400 to be communicable with each other. The server may be a so-called local server, or may be a virtual server (for example, a cloud server) constructed using resources on a network, or the like.

Furthermore, the processing executed by the information providing device 400 may be executed by an external device such as a smartphone or a server, or may be executed by being distributed to a plurality of devices or servers. In a case where the processing is distributed and executed by the plurality of devices or servers, any device may execute any processing.

For example, the level of the user may be determined from the ID of the user or the operation content by the injection molding machine 10, and the determined level may be transmitted to the external server or the like. The server that has acquired the level determines information of the advice to be provided to the user, based on the level. The information of the advice may be transmitted to the injection molding machine 10 and displayed on the display unit 300, or may be transmitted to a terminal used by the user and displayed. In this case, the injection molding machine 10 that determines the level can be regarded as an example of the acquisition means. In addition, the server is an example of acquisition means that acquires the level, and can be regarded as an example of information providing means that changes the information of the advice according to the level. In addition, in a case where the terminal displays the information of the advice, the terminal can be regarded as an example of the information providing means that changes the information of the advice to be provided according to the level.

In addition, the determined level may be transmitted to the terminal used by the user, the information on the advice to be provided to the user by the terminal may be determined, and the information of the advice may be displayed on the terminal. In this case, the terminal is an example of acquisition means that acquires the level, and can be considered as an example of information providing means that changes the information of the advice according to the level.

In addition, it is clear from the description of the claims that combinations two or more of the above embodiments, as well as various changes or improvements made to the above embodiments, are also included in the technical scope of the present disclosure.

It should be understood that the invention is not limited to the above-described embodiment, but may be modified into various forms on the basis of the spirit of the invention. Additionally, the modifications are included in the scope of the invention.

What is claimed is

1. A molding machine comprising:
an acquisition unit that acquires a level of a user determined using a classification criterion; and
an information providing unit that provides information to the user,
wherein the information providing unit changes, according to the level acquired by the acquisition unit, information of advice to be provided regarding a function that is available to any of a plurality of users whose levels acquired by the acquisition unit are different.

2. The molding machine according to claim 1,
wherein the acquisition unit acquires the level of the user from an external device that is provided outside the molding machine and determines the level of the user based on the classification criterion.

3. The molding machine according to claim 1,
wherein the classification criterion for the levels is a time required for an operation or the number of times of execution of the operation.

4. The molding machine according to claim 1,
wherein the classification criterion for the levels is an operation content of the user including a checked setting value and a screen checked during an operation.

5. The molding machine according to claim 1,
wherein the classification criterion for the levels is user attributes including an input of a password and a job title.

6. The molding machine according to claim 1, further comprising:
an operation content receiving unit that receives and acquires an operation content from the user.

7. The molding machine according to claim 6,
wherein a determination unit that determines the level of the user based on the operation content acquired by the operation content receiving unit is included as the acquisition unit.

8. The molding machine according to claim 7,
wherein a provision information determination unit that determines information to be provided to the user based on the level of the user determined by the determination unit is included as the information providing unit.

9. The molding machine according to claim 8, further comprising:
a display control unit that causes a display unit to display the information of advice to be provided to the user determined by the provision information determination unit.

10. The molding machine according to claim 1,
wherein the level is an index indicating a skill level of work.

11. The molding machine according to claim 1,
wherein the level indicates a role of the user.

12. The molding machine according to claim 1,
wherein the information providing unit provides information of advice required to execute work to a user whose level determined using the classification criterion is low.

13. The molding machine according to claim 12,
wherein the information providing unit provides information of advice related to an execution procedure of the work to the user whose level determined using the classification criterion is low.

14. The molding machine according to claim 1,
wherein the information providing unit provides information of advice for improving a quality of a molding product to a user whose level determined using the classification criterion is low.

15. The molding machine according to claim 1,
wherein the information providing unit provides information of advice having added value to a user whose level determined using the classification criterion is high.

16. The molding machine according to claim 15,
wherein the information providing unit provides information of advice for reducing energy consumption to the user whose level determined using the classification criterion is high.

17. The molding machine according to claim 15,
wherein the information providing unit provides information of advice for reducing a mold clamping force to the user whose level determined using the classification criterion is high.

18. The molding machine according to claim 15,
wherein the information providing unit provides information of advice for shortening a cycle to the user whose level determined using the classification criterion is high.

19. An information providing device comprising:
an acquisition unit that acquires a level of a user determined using a classification criterion; and
a provision information determination unit that determines information to be provided to the user,
wherein the provision information determination unit changes, according to the level acquired by the acquisition unit, information of advice to be provided regarding a function that is available to any of a plurality of users whose levels acquired by the acquisition unit are different.

20. An information providing device comprising:
an acquisition unit that acquires information of advice, which is changed according to a level of a user determined using a classification criterion, to be provided regarding a function that is available to any of a plurality of users whose levels are different; and
an information providing unit that provides the information of advice acquired by the acquisition unit to the user.
